(19) United States
(12) Patent Application Publication
(10) Pub. No.: US 2024/0063736 A1
(43) Pub. Date: Feb. 22, 2024

(54) METHOD FOR CONTROLLING A CONVERTER

(71) Applicant: Wobben Properties GmbH, Aurich (DE)

(72) Inventors: Roberto Rosso, Aurich (DE); Johannes Warsinski, Unterschleißheim (DE); Christoph Greiwe, Aurich (DE)

(21) Appl. No.: 18/450,287

(22) Filed: Aug. 15, 2023

(30) Foreign Application Priority Data
Aug. 16, 2022 (EP) 22190580.5

(51) Int. Cl. H02P 9/02; F03D 9/25; H02K 7/18

(52) U.S. Cl. CPC H02P 9/02; F03D 9/255; H02K 7/183; F05D 2220/76

(57) ABSTRACT

The disclosure relates to a method for parameterizing a converter, in particular a converter of a wind power installation, comprising the steps of: defining an operating situation of the converter in which the converter is electrically connected to an electric machine; simulating and/or operating the converter in the operating situation; acquiring an acoustic, in particular vibroacoustic, quantity of the electric machine; and determining a parameter for the converter in consideration of the acoustic quantity for the operating situation, in particular such that the acoustic quantity is minimized.

### BACKGROUND

### Technical Field

The present invention relates to a method for parameterizing a converter, and to a method for controlling a thus parameterized converter, and also to a wind power installation having a thus parameterized converter.

### Description of the Related Art

The driving of converters, or converter systems, may be effected by means of a multiplicity of different driving methods such as, for example, a PWM or a tolerance band method.

Irrespective of the driving method, harmonics can occur in the inverter currents, which in turn can result in audible vibrations in electrically adjacent machines.

In the field of wind power installations, in particular, these audible vibrations can result in major problems. For example, the generator of a wind power installation can generate sound emissions that are above legal standards, resulting in curtailment and/or shutting-down of the wind power installation.

### BRIEF SUMMARY

In particular, a method for parameterizing and/or controlling a converter is to be provided that results in a reduction in audible vibrations and/or noise at a generator.

Proposed is a method for parameterizing a converter, in particular a converter of a wind power installation, comprising the steps of: defining an operating situation of the converter in which the converter is electrically connected, or electrically coupled, to an electric machine; simulating or operating the converter in the operating situation; acquiring an acoustic, in particular vibroacoustic, quantity of the electric machine; and determining a parameter for the converter in consideration of the acoustic quantity for the operating situation, in particular such that the acoustic quantity is minimized.

There is thus proposed, in particular, a method for parameterizing a converter of a wind power installation by which noise and/or vibrations of a generator connected to the converter can be minimized.

In a first step, a corresponding operating situation is defined for the converter, the converter in this operating situation being connected, or electrically coupled, to an electric machine.

The electric machine in this case may be any electric machine, for example a synchronous machine, an asynchronous machine or the like. Preferably, the electric machine is a generator, in particular a synchronous generator, preferably a separately excited synchronous generator, of a wind power installation.

An operating situation would then be, for example, the so-called full-load operation of the wind power installation. However, other operating situations are also conceivable, such as, for example, the so-called partial-load operation of the wind power installation, the night operation of the wind power installation or the like.

The method described here may be used for any operating situation. The method may also be performed for a plurality of operating situations in succession or simultaneously.

In a next step, the operating situation is simulated by use of a corresponding model and/or created by means of a test setup and/or a test facility.

For this purpose, for example, the wind power installation may be modelled and simulated in a program such as Matlab, or the operating situation created on a test stand or at a test facility.

During simulation and/or test operation, at least one acoustic quantity, in particular a vibroacoustic quantity, of the electric machine is then acquired.

The acoustic quantity may be any physical quantity that indicates or describes vibrations. Acoustic quantities resulting from vibrations, or oscillations, of structural components are also referred to as vibroacoustic quantities. Preferably, the acoustic quantity is a loudness and/or a vibration of a generator of a wind power installation.

The acoustic quantity may be acquired, simulated or estimated directly or indirectly. Preferably, the acoustic quantity is acquired near or directly on the electric machine. For example, a test facility is used and the acoustic quantity is measured directly by means of a microphone. However, the acoustic quantity may also be acquired indirectly in the test facility, for example by means of a strain gauge and/or a current measurement and/or a laser measurement and/or a camera or the like.

Preferably, multiple measurements are performed for acquiring the acoustic quantity, preferably also in a wide variety of operating situations, in particular by means of so-called measurement campaigns. The quantities acquired in this way may then be evaluated and/or prepared stochastically and/or statistically, for example by classification, averaging or the like.

In a next step, at least one parameter for the operating situation is determined in consideration of the acoustic quantity. In particular, in this case the parameter is selected and/or determined in such a way that the acoustic quantity is minimized.

This parameter selected in this way is then stored in a database, a look-up table, a control system or the like for the original operation. In the case of a wind power installation, for example, the parameter thus determined would be set accordingly in a control system, and the wind power installation would then generate a corresponding current, for example a corresponding stator and rotor current, in consideration of this parameter.

It is thus also proposed, in particular, that a converter be parameterized and operated accordingly in consideration of the electric machine connected to the converter, in particular in such a way that the electric machine generates fewer and/or other sound emissions.

The method described herein is thus used in particular to set the parameters of a converter and/or of a converter control unit (e.g., converter controller) and/or a converter control system. In particular, the method described herein may be used to optimize operating parameters of a wind power installation in respect of sound. Preferably, the method for parameterizing is executed off-line. Nevertheless, the method could also be integrated in the form of an active closed-loop control.

Here, a parameter is understood in particular as an settable, or programmable, variable that is stored in a control unit (e.g., controller) or the like. Such parameters are usually used to dimension and/or limit open-loop and/or closed-loop control systems. Such parameters are often also referred to as operating parameters. Examples of such parameters include, inter alia, gain factors, band limits, limit values and the like.

Preferably, the acoustic quantity is a noise level of a wind power installation, preferably of a generator of the wind power installation.

The acoustic quantity thus indicates in particular how loud the wind power installation and in particular the generator of the wind power installation are. Particularly preferably, the acoustic quantity may be used to represent the tonality of the wind power installation, in particular in relation to its surroundings.

Preferably, the parameter alters a stator current and/or an excitation current and/or influences the saturation state of the electric machine.

Thus, in particular, the parameter influences the stator current and/or the excitation current and/or the saturation state of a generator of a wind power installation.

In particular, the electric-current setpoints, preferably for the stator current and/or the excitation current, further preferably in combination, are selected in such a way that the generator is intentionally driven into saturation. This is because it has been found that deliberately driving the generator into saturation has a positive effect on the sound emissions of the generator. In particular, saturation results in the same, or similar, current ripples, but in lower forces, or force levels, within the generator, or air gap.

Preferably, the parameter is for an active rectifier and/or converter of a wind power installation.

For example, the parameter is for an active rectifier that is electrically connected to a stator of a generator of a wind power installation. The parameter is thus used, in particular, to impress a particular stator current into the stator of the generator.

Alternatively or additionally, the parameter is for a converter of a wind power installation that impresses an excitation current into the rotor of the generator.

The parameter may thus be used to set both an excitation current and a stator current of a generator of a wind power installation. Preferably, the parameter is used to set a stator current and a rotor current at the same time, i.e., in combination, in particular such that the generator has different and/or fewer sound emissions.

Preferably, the parameter describes an optimization space for an optimization algorithm, in which the acoustic quantity is below a predetermined limit value and in which the optimization algorithm searches for stator current and/or an excitation current, in particular for a combination of stator and excitation current, that fulfils a, preferably higher-level, power specification.

The parameter therefore does not directly influence the excitation current and/or the stator current, but merely specifies a particular optimization space for an optimization algorithm.

This optimization space preferably includes only solutions that result in an acceptable acoustic quantity, i.e., an acoustic quantity that is below a predetermined limit value.

The optimization algorithm, for example the MEPA method described herein, then searches in this optimization space for combinations of excitation and stator current that, in particular, satisfy a power specification that comes, for example, from a higher-level closed-loop power control system of the wind power installations.

Further proposed according to the disclosure is a method for controlling a wind power installation proposed, comprising the steps of: providing a parameter of a converter of the wind power installation, the parameter having been determined by a method described above or below; and generating a current by means of the converter in consideration of the parameter.

For this purpose, the parameter may be set, for example, in a control system, in particular in a converter control system, and/or stored in a database or a look-up table. The control system then accordingly accesses this database or look-up table and controls the converter accordingly. By this means, the converter generates a current in dependence on the parameter, in particular as described above or below.

What is particularly advantageous in the method described herein is the simple manner of implementation and/or the relatively small alteration in switching losses compared to similar methods.

Preferably, the current is an excitation current and/or a stator current of the wind power installation.

The method described here for controlling a wind power installation is thus, in particular, intended for setting a current, preferably a current of a generator of a wind power installation, preferably a combination of excitation current and stator current. The stator current in this case is preferably a 3-phase alternating current, and/or the excitation current is preferably a direct current.

It is thus also proposed, in particular, that both the excitation current of the generator of the wind power installation and the stator current of the generator of the wind power installation be set in dependence on the parameter, in particular in such a way that the generator and/or the wind power installation has lower and/or different sound emissions.

Preferably, the stator current is set by means of d/q coordinates.

It is thus proposed, in particular, that the stator current be controlled by means of d- and/or q-components, and that the d- and/or the q-component beset in dependence on the acoustic quantity in such a way that the acoustic quantity decreases, or the generator emits less and/or different sound.

The d-component may be used, for example, to set a radial quantity of a generator of a wind power installation, in particular a radial force component and/or the magnetic flux density in the rotor of the generator.

The q-component may be used, for example, to set a tangential quantity of a generator of a wind power installation, in particular a tangential force component and/or the torque of a rotor of the generator.

Particularly preferably, both the d-component and the q-components are set, controlled by closed-loop control and/or by open loop control by the method described herein.

Preferably, the current is determined in dependence on an operating point and/or a power specification.

In particular, the excitation current and the stator current are determined in dependence on an operating point of the generator and a power specification for the generator, and are generated accordingly. The operating point may be determined, for example, by a model, and/or the power specification may be effected by a higher-level power closed-loop control system of the wind power installation.

It is thus also proposed that, in addition to the acoustic quantity, further electrical quantities and/or mechanical quantities of the generator and/or the wind power installation be taken into consideration in order to generate the current.

Preferably, the current, in particular the excitation current and/or the stator current, is generated by use of an optimization algorithm, which preferably seeks a maximum output of a generator of the wind power installation.

An example of such an optimization algorithm, or such an optimization method, is the “Maximum Efficiency per Ampere” method (MEPA for short). In particular, the algorithm in this case has a boundary condition that results in a maximum output power per ampere.

Another example of such an optimization algorithm is the “Maximum Torque per Ampere” method (MTPA for short).

Preferably, the parameter specifies an optimization space for the optimization algorithm, in particular in which the optimization algorithm searches for a combination of stator and excitation current in order to fulfil a power specification.

The parameter may thus also comprise, for example, two or more values, which in particular mark a particular range or describe a particular space. The parameter thus serves the optimization algorithm in particular as a limit or boundary condition, or boundary.

For example, the parameter specifies an upper and a lower limitation, and the optimization algorithm searches between these values for those values for the excitation and/or stator current that, preferably in combination, provide the maximum output power per ampere.

By means of such a procedure it can be ensured, in particular, that even an optimization algorithm for the power of the generator cannot cause the generator to become too noisy during operation.

Preferably, the method for controlling a wind power installation further comprises the step of: increasing the actual power of a generator of the wind power installation, in particular with rotational speed remaining unchanged, in particular if a predetermined limit value for the acoustic quantity has been exceeded and/or a particular operating mode of the wind power installation has been activated.

It is thus also proposed, in particular, that the acoustic quantity be monitored during operation of the wind power installation, for example by means of a microphone or the like, and that if the acoustic quantity exceeds a predetermined limit value, the actual power of the generator be increased while the rotational speed remains substantially unchanged.

Preferably, this increasing of the actual power is effected only and/or only when, for example, a particular operating mode is active or has been activated, for example when the wind power installation switches from a day mode to a night mode or vice versa. The increasing of the actual power at substantially unchanged rotational speed can therefore only be performed if a particular prerequisite is present, or the increasing of the actual power is enabled.

Alternatively or additionally, the excitation current and/or the stator current is altered, in particular in order to achieve a higher saturation state of the generator, in particular if a predetermined limit value for the acoustic quantity has been exceeded and/or a particular operating mode of the wind power installation has been activated.

It is thus also proposed, in particular, that the generator be deliberately driven into saturation if the generator, or the wind power installation, is too loud, i.e., in particular if the acoustic quantity exceeds a predetermined limit value.

Preferably, the generator is driven into saturation by alteration of the excitation current and/or the stator current.

Also proposed is a wind power installation comprising a generator that has a stator having an axis of rotation about which a rotor is rotatably mounted, and a converter, in particular an active rectifier, which is connected to the stator and which can be connected to an electrical supply grid; and a control unit for the converter, which is configured to execute a method described herein.

Preferably, the control unit is realized as an adaptive closed-loop controller that, in particular, takes into consideration the magnetic saturation of the generator.

It is thus proposed, in particular, that the control unit take into consideration the current system state of the generator, for example by means of a mathematical model that takes into consideration the physical relationships of a generator.

By means of adaptive closed-loop control, in particular significantly more optimal operating points for the generator can be found than with conventional control systems or the like, which in particular are not designed to be adaptive.

The adaptive closed-loop controller in this case takes into consideration at least the magnetic saturation of the generator.

However, other physical and/or mechanical and/or electrical quantities that describe the current state of the generator, such as the temperature, the rotational speed, the iron losses or the like, may also be taken into consideration.

Preferably, the adaptive closed-loop controller also has an observer at the input, in particular a Kalman filter, which estimates corresponding values for the m

Preferably, the control unit comprises at least one model of the generator and/or an optimization unit and/or a driver unit, in particular as described above or below.

Particularly preferably, the optimization unit comprises at least one optimization algorithm and/or a database in which are stored the parameters that have been determined by means of a method for parameterizing a converter and/or by means of which the wind power installation is to be controlled.

Further preferably, the control unit comprises a higher-level closed-loop power control system that provides a power specification.

### BRIEF DESCRIPTION OF THE SEVERAL VIEWS OF THE DRAWINGS

The present invention is explained in greater detail below with reference to the accompanying figures, with the same reference designations being used for components or assemblies that are the same or similar.

FIG. 1A shows, as an example, a schematic, perspective view of a wind power installation in one embodiment.

FIG. 1B shows, as an example, a schematic structure of an electrical branch of a wind power installation in one embodiment.

FIG. 2 shows a schematic sequence of a method according to one embodiment.

FIG. 3 shows a schematic structure of a control unit of a converter of a wind power installation according to one embodiment.

### DETAILED DESCRIPTION

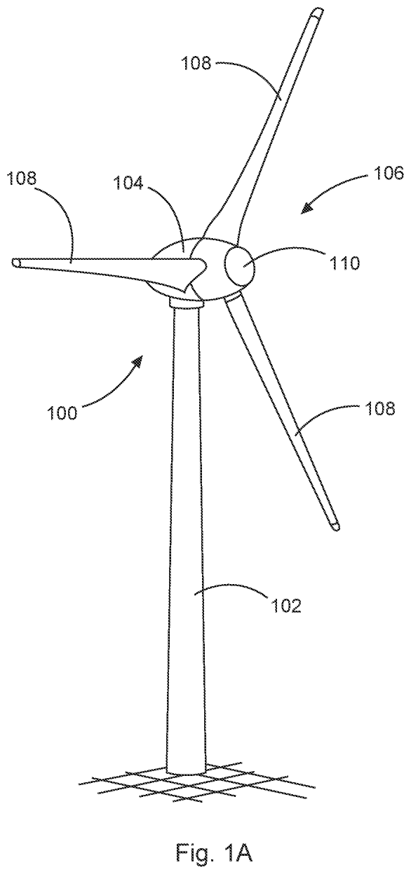

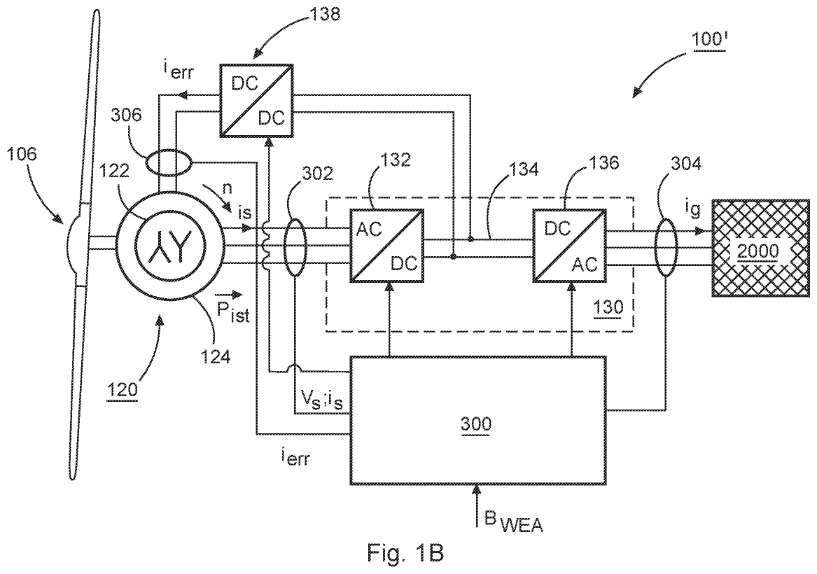

FIG. 1A shows, as an example, a schematic, perspective view of a wind power installation 100.

The wind power installation 100 has a tower 102 and a nacelle 104.

Arranged on the nacelle 104 there is an aerodynamic rotor 106 comprising a hub 110.

Arranged on the hub 110, in particular symmetrically with respect to the hub 110, there are three rotor blades 108, preferably offset by 120° with respect to one another.

The wind power installation 100 is preferably realized as a lift-type rotor with a horizontal axis and three rotor blades 108 on the windward side, in particular as a horizontal rotor.

FIG. 1B shows in schematic form, as an example, an electrical branch 100′ of a wind power installation 100, in particular as shown in FIG. 1A.

The wind power installation 100 has an aerodynamic rotor 106 that is mechanically connected to a generator 120 of the wind power installation 100. Wind causes the aerodynamic rotor 106 to rotate, thereby driving the generator 120.

The generator 120 has a stator 122 and a rotor 124. Preferably, the generator 120 is realized as a 6-phase and/or externally excited synchronous generator, in particular having two three-phase stator systems 122, 124, which are phase-shifted by 30 degrees and electrically decoupled from each other.

The generator 120 is electrically connected to an electrical supply grid 2000 via a converter 130 and, for example, a transformer of the wind power installation.

The converter 130 converts the electrical power generated by the generator 120 into a three-phase alternating current i_{g} that is to be fed in. For this purpose, the converter 130 is preferably realized as a converter system, i.e., the converter comprises a plurality of converter modules, which are preferably interconnected in parallel.

The converter 130 comprises a rectifier 132, in particular an active rectifier, optionally an intermediate circuit 134, and an inverter 136. Preferably, the converter 130 is designed, or the converter modules are designed, as a direct converter (back-to-back converter).

In addition, an excitation 138, which excites the generator 120 externally by means of an excitation current i_{excitation}, is brought out from the converter 130, in particular from the d.c. intermediate circuit 134. A further rectifier 138, for example, may be provided for this purpose.

The converter is 130 controlled by means of a control unit 300 (e.g., controller). The control unit 300 may also be referred to as the inverter control unit. Preferably, the control unit 300 is connected to a control unit of the wind power installation and/or to a grid operator in order to receive target specifications Bwea, for example for the current i_{g} that is to be fed in or for the power P_{target} that is to be generated.

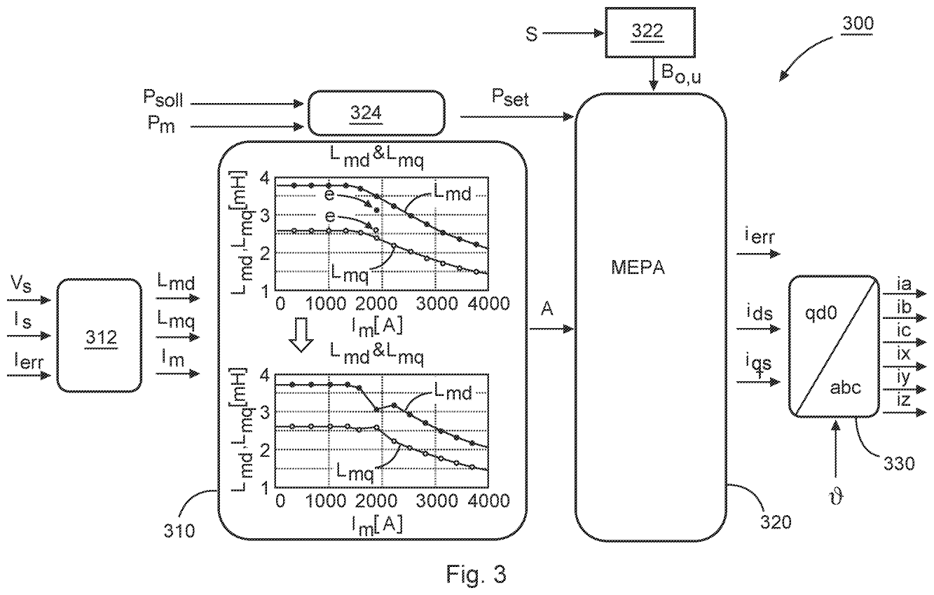

The control unit 300 is configured, in particular, to drive the rectifier 132, preferably the active rectifier 132, using a method described herein. For this purpose, the control unit 300 has various measuring units (e.g., ammeters) 302, 304, 306, for example for acquiring a stator current is, for acquiring the current i_{g} to be fed in, or for acquiring an excitation current i_{excitation} or the like. However, the control unit may also have further or other measuring and/or acquisition units, for example for measured quantities as described in FIG. 3.

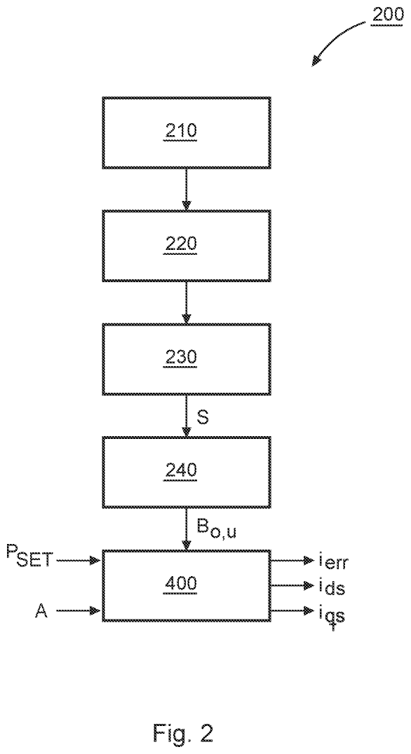

FIG. 2 shows a schematic sequence 200 for parameterizing a converter, such as that shown, for example, in FIG. 1B.

In a first step 210, an operating situation of a converter is defined, in which the converter is connected to a generator of a wind power installation.

In a second step 220, a simulation is performed for this operating situation of the converter, and/or a corresponding converter is operated in such a way in a test stand or test facility.

In a third step 230, during this simulation and/or during operation an acoustic quantity S is acquired, in particular the loudness of the generator. Particularly preferably, this is done for a plurality of operating points and by a plurality of measurements.

In a fourth step 240, a parameter B_{o,u} is determined for the converter 130 in consideration of the acoustic quantity S thus acquired. In particular, the parameter B_{o,u} in this case is selected in such a way that the sound emission of the generator alters and/or decreases.

According to one embodiment, the parameter B_{o,u} determined in this way is then set in the control unit of the wind power installation, or stored in a corresponding database.

The wind power installation, or wind power installations of the same design, are then operated accordingly by means of a method 400 in dependence on an operating point A of the generator and in consideration of the parameter B_{o,u}; in particular the i_{excitation} current and the stator current i_{ds}, i_{qs} of the generators are determined, or generated, by use of an optimization algorithm and in dependence on the operating point A and the parameter B_{o,u}.

FIG. 3 shows a schematic structure of a control unit 300 of a converter of a wind power installation according to one embodiment, in particular of a converter 130 and a wind power installation 100 as shown in FIGS. 1A and 1B.

The control unit 300 in this cases comprises, in particular, a model of the generator 310, an optimization unit 320 and a driver unit 330. The control unit in this case is preferably realized as an adaptive closed-loop controller.

The generator model 310 represents the generator 120 of the wind power installation 100 in a mathematical model that takes into consideration the corresponding physical relationships of a generator, and determines a current operating point A of the generator from corresponding measurement and/or estimation data. For example, this operating point is determined from the stator voltage V_{S}, the stator current is and the excitation current i_{excitation}. For this purpose, for example the magnetic inductances L_{md}, L_{mq} and the magnetizing current i_{M} are estimated by means of an observer 312, such as a Kalman filter, for example from the stator voltage V_{S}, the stator current is and the excitation current i_{excitation}. A corresponding operating point A is then determined from this in consideration of the model of the generator 310. The model of the generator 310 takes into consideration, in particular, the magnetic saturation of the generator in dependence on the operating point, or the magnetic inductances L_{md}, L_{mq} in dependence on the magnetizing current i_{M}. However, the model may also take other physical relationships into consideration, such as any stator losses or the like.

The optimization unit 320 determines the excitation current i_{excitation} for the generator, the d component of the stator current i_{ds} and the q component of the stator current i_{qs} by use of an optimization algorithm such as, for example, the MEPA method. For this purpose, the optimization unit 320 takes into consideration a power specification Pₛₑₜ, a parameter B_{o,u} and the current operating point of the generator A.

The power specification Pₛₑₜ is specified, for example, by a higher-level power unit 324, or a higher-level power control system, for example on the basis of an electrical target power P_{target} for the generator and a mechanical power of the generator Pₘ, which is determined, for example, via the rotational speed n. Preferably, the power unit 324 is realized as a PI closed-loop controller.

The parameter B_{o,u} for the optimization space is specified by a parameter unit 322. The parameter unit 322 comprises, for example, a look-up table, which is populated with parameters that have been determined by a method described herein for parameterizing a converter. In particular, the parameters B_{o,u} have been determined in dependence on an acoustic quantity S. In particular, the parameters B_{o,u} thus specify a working field for the optimization algorithm of the optimization unit 320.

The optimization unit 320 thus determines the excitation current i_{excitation}, the d component of the stator current i_{ds} and the q component of the stator current i_{qs} in dependence on the parameter B_{o,u}. In particular, the parameter B_{o,u specifies} particular ranges to which the optimization algorithm may only be applied. In this way it can be guaranteed, in particular, that the acoustic quantity S does not exceed a predetermined limit value, even if a power optimization algorithm, shown by the power unit 324, is used within the control system of the wind power installation.

The excitation current i_{excitation} for the generator is used to set the excitation current at the generator, as shown, for example, in FIG. 1B.

The d component of the stator current i_{ds} and the q component of the stator current i_{qs} are given to the driver unit 330 of the active rectifier.

From the d/q components i_{ds}, i_{dq}, the driver unit 330 calculates the abc coordinates for the stator current is. If the generator is designed as a 6-phase generator having two three-phase stator systems 122, 124, as shown, for example, in FIG. 1B, the driver unit determines the abc coordinates iₐ, i_{b}, i_{c} for the first stator system 122 and the abc coordinates iₓ, i_{y}, i_{z} for the second stator system 124. Preferably, the abc coordinates are determined in consideration of a temperature θ, in particular a generator temperature.

### LIST OF REFERENCE DESIGNATIONS

100 wind power installation
100′ electrical branch, in particular of a wind power installation
102 tower, in particular of the wind power installation
104 nacelle, in particular of the wind power installation
106 aerodynamic rotor, in particular of the wind power installation
108 rotor blade, in particular of the wind power installation
110 hub, in particular of the wind power installation
120 generator, in particular 6-phase generator of the wind power installation
122 stator, in particular electrical stator of the generator
122′ first three-phase system, in particular of the stator
122″ second three-phase system, in particular of the stator
124 rotor, in particular electrical rotor of the generator
130 converter, in particular power converter of the wind power installation
132 rectifier, in particular active rectifier of the converter
134 intermediate circuit, in particular of the converter
136 inverter, in particular of the converter
138 rectifier, in particular of the converter
200 method for controlling a converter
210 step: defining an operating situation
220 step: simulating and/or operating the converter
230 step: acquiring an acoustic quantity
300 control unit of a converter, in particular of an active rectifier
310 model of the generator
320 optimization unit, in particular of the control unit
322 parameter unit, in particular of the control unit
324 power unit, in particular of the control unit
330 driver unit, in particular of the converter
2000 electrical supply grid
A operating point, in particular of the generator
B_{o,u} parameter, in particular for an operating range
i_{g} current i_{g} to be fed in
i_{S} stator current
iₐ, i_{b}, i_{c} stator current, in particular in abc coordinates
iₓ, i_{y}, i_{z} stator current, in particular in abc coordinates
i_{dS} d component, in particular of the stator current
i_{qS} q component, in particular of the stator current
i_{excitation} excitation current
Lmd, Lmq magnetic inductances, in particular of the generator
MEPA optimization algorithm
n rotor rotational speed
P_{ActualPower} actual electrical power, in particular of the generator
Pₛₑₜ power specification, for the generator
P_{target} target electrical power, in particular for the generator
Pₘ mechanical power, in particular of the generator
S acoustic quantity
v_{S} stator voltage
θ temperature, in particular of the generator

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for parameterizing a converter, comprising:
defining an operating situation of the converter in which the converter is electrically connected to an electric machine;
simulating or operating the converter in the operating situation;
acquiring an acoustic quantity of the electric machine; and
determining a parameter for the converter in consideration of the acoustic quantity for the operating situation.

2. The method for parameterizing the converter according to claim 1, wherein the converter is a wind power installation converter, the acoustic quantity is a vibroacoustic quantity and the parameter for the converter is determined such that the acoustic quantity is minimized.

3. The method for parameterizing the converter according to claim 1, wherein the acoustic quantity is a noise level of a generator of a wind power installation.

4. The method for parameterizing the converter according to claim 1, wherein the parameter alters a stator current or an excitation current or influences a saturation state of the electric machine.

5. The method for parameterizing the converter according to claim 1, wherein:
the parameter is for an active rectifier of a wind power installation, which is electrically connected to a stator of a generator of the wind power installation, in order to impress a stator current; or
the parameter is for a converter of the wind power installation, which is electrically connected to a rotor of the generator of the wind power installation, in order to impress an excitation current.

6. The method for parameterizing the converter according to claim 1, wherein:
the parameter describes an optimization space for an optimization algorithm, in which:
the acoustic quantity is below a predetermined limit value; and
the optimization algorithm searches for an excitation current or a stator current for a combination of stator and excitation current that fulfils a power specification.

7. A method for controlling a wind power installation, comprising:
providing a parameter of a converter of the wind power installation, the parameter having been determined by the method according to claim 1; and
generating a current by means of a converter in consideration of the parameter.

8. The method for controlling the wind power installation according to claim 7, wherein the current is an excitation current or a stator current of the wind power installation.

9. The method for controlling the wind power installation according to claim 8, wherein the stator current is set by means of d/q coordinates.

10. The method for controlling the wind power installation according to claim 7, wherein the current is determined in dependence on an operating point or a power specification.

11. The method for controlling the wind power installation according to claim 7, wherein the current is determined by an optimization algorithm.

12. The method for controlling the wind power installation according to claim 11, wherein the parameter specifying an optimization space for the optimization algorithm in which the optimization algorithm searches for a combination of stator and excitation current in order to fulfil a power specification.

13. The method for controlling the wind power installation according to claim 7, comprising:
increasing an actual power of a generator of the wind power installation, with rotational speed remaining unchanged, if a predetermined limit value for the acoustic quantity has been exceeded or a particular operating mode of the wind power installation has been activated; or
altering an excitation current or a stator current in order to achieve a higher saturation state of the generator if the predetermined limit value for the acoustic quantity has been exceeded or a particular operating mode of the wind power installation has been activated.

14. A wind power installation, comprising:
a generator that has a stator having an axis of rotation about which a rotor is rotatably mounted; and
a converter, which is connected to the stator and which can be connected to an electrical supply grid; and
a controller for the converter, which is configured to execute the method according to claim 7.

15. The wind power installation according to claim 14, wherein the converter is an active rectifier.

16. A wind power installation, comprising:
a controller, realized as an adaptive closed-loop controller that, takes into consideration magnetization inductances of a generator by an estimation by means of a Kalman filter observer.

17. The wind power installation according to claim 16, wherein the controller comprises a model of the generator, an optimization unit or a driver unit.
